(19) United States
(12) Patent Application Publication
(10) Pub. No.: US 2013/0202231 A1
(43) Pub. Date: Aug. 8, 2013

(54) COMPOSITE FILM BAG FOR PACKAGING BULK PRODUCTS

(71) Applicant: COATING EXCELLENCE INTERNATIONAL LLC, Wrightstown, WI (US)

(72) Inventors: Michael R. Nowak, Seymour, WI (US); Cori K. Kohl, Appleton, WI (US); Andrew Austreng, Appleton, WI (US)

(73) Assignee: COATING EXCELLENCE INTERNATIONAL LLC, Wrightstown, WI (US)

(21) Appl. No.: 13/826,707

(22) Filed: Mar. 14, 2013

Related U.S. Application Data
(63) Continuation of application No. 11/538,838, filed on Oct. 5, 2006, now abandoned.
Application No. 11/538,838 is a continuation-in-part of application No. 11/244,691, filed on Oct. 6, 2005, now abandoned.

(51) Int. Cl. B65D 33/00; B31B 49/04

(52) U.S. Cl. CPC B65D 33/00; B31B 49/04
USPC 383/203; 383/63; 383/64; 383/211; 383/200; 493/220

(57) ABSTRACT

The present invention relates to a multi-layered composite bag used to store bulk type products such as pet food, seeds, fertilizer, cereals, grains, charcoal, sand, gravel, and other bulk products, including without limitation bulk products intended for human and non-human consumption, and provides a more efficient manufacturing process than using a paper/plastic structure. The present invention provides a bag comprising a middle layer of woven mesh tubing to which an outer layer of solid plastic film is adhered using polypropylene or other polylaminates.

### CROSS-REFERENCE TO RELATED APPLICATIONS

This application is a continuation of application Ser. No. 11/538,838, filed Oct. 5, 2006, which is a continuation-in-part of application Ser. No. 11/244,691, filed Oct. 6, 2005.

### FIELD OF THE INVENTION

The present invention relates to a composite bag suitable for packaging bulk products, including bulk food items, pet food, grains and cereals, seeds, fertilizers and other bulk articles.

### BACKGROUND OF THE INVENTION

Conventional bags used to package bulk products, such as dog food, cereals, seeds and fertilizers are composed of multiple layers of paper and solid plastic films. The outer ply typically includes a polymer-coated paper with a smooth printing surface. The paper may be laminated to a layer of film and another paper layer. One drawback of such bags used for bulk products is the difficulty of incorporating several composite layers of film and paper, in order to achieve adequate strength. Another drawback of such bags is the worn appearance of bags comprised of printed paper structures.

In overseas markets, bags for bulk products are often made without paper, and include a middle layer of woven mesh material to which a pre-printed plastic film is adhered. The woven mesh material typically includes sheets of polypropylene film, which are cut into narrow strips and then woven together to form a woven mesh or net-like material. Some imported bags are composed of mesh tubes containing polypropylene, to which a solid polypropylene film is adhered. Other bags are composed of polypropylene mesh or net-like sheets, which are adhered to a sheet of solid polypropylene and formed on bagging equipment to incorporate a side seam. The layer of film provides a smooth surface for printing graphics. The pre-printed film contains polypropylene, as is the woven mesh to which it is adhered. The bags are sewn, stapled, laced, or stitched shut on the top and bottom.

A disadvantage of mesh/film polypropylene bags used overseas is that the outer film layer is overly smooth and slippery, causing problems on packaging equipment and in warehousing the bagged product. Because of the slipperiness of the outer film layer, the bags do not stack well and slide when stacked and stored on warehouse shelves, and/or when transported on pallets. The slickness of the film may also cause problems on high-speed packaging equipment. Another common problem associated with mesh/film polypropylene bags used overseas is inconsistent adhesion between the film and woven mesh layers, which often leads to frequent separation of the laminated structure and deterioration of the strength and integrity of the bag. Moreover, the print quality of overseas bags is highly inconsistent and usually involves solvent-based inks, making the packaging incompatible with bulk products intended for human consumption. Overseas and domestic bags also lack performance integrity to withstand outside storage, making the print vulnerable to deterioration when exposed to ultraviolet (UV) light.

Both domestic and foreign markets demand a composite bag with excellent printability and adequate strength for storing bulk products. These bags must also prevent slippage during manufacturing, transporting, and storing, and be composed of materials that meet the strength and performance needs of the marketplace. Such bags should be of sufficient integrity suitable for outside storage, UV protection, and complete adhesion between the film and mesh/woven layers. Such bags also should be comprised of materials that can be easily and readily adapted to high-speed bag equipment, and should incorporate materials that are compatible with products intended for human and non-human consumption.

### SUMMARY OF THE INVENTION

The present invention relates to a multi-layered composite bag used to store bulk type products such as pet food, seeds, fertilizer, cereals, grains, charcoal, stones, sand and other bulk products, including without limitation bulk products intended for human and non-human consumption, and provides a more efficient manufacturing process than using a paper/plastic structure. The present invention provides a bag comprising a middle layer of woven mesh tubing to which an outer layer of solid plastic film is adhered using polypropylene or other polylaminates.

In accordance with the present invention, the outside layer of film (comprising the outside of the bag) may be printed or reverse-printed with graphics and product labeling. Solid films are utilized, which provide excellent printability and strength, and meet or exceed performance standards dictated by the marketplace.

The present invention uses films that are treated or coated to prevent slippage of bags during manufacturing, packaging, transport and storage. The materials to be used may partially or wholly comprise compostable, degradable or recyclable materials. The present invention also incorporates the use of alternative films and woven mesh materials.

It is an object of the present invention for the bag to comprise a woven mesh material formed into a tube to which a solid plastic film is adhered using a lamination process. The mesh material is comprised of a suitable film-forming plastic resin that is split and/or stretched and then woven to form a mesh or net-like material. The woven mesh material is formed into a tubular shape to easily adapt to high-speed bag-forming equipment. The tube, which is flattened and gusseted, is then fed into a laminator with one or two extruders, and laminated on both sides of the flattened tube to a solid plastic film using polypropylene or other polylaminate.

Among the alternative films that can be employed in making the mesh tubes are, without limitation, thermoplastic synthetic polymers, including polyolefins such as low density polyethylene, linear low density polyethylene, polypropylene coated with a layer of polyethylene, high density polyethylene, metallocene, electron-beam cured solid films, copolymers of ethylene and propylene and combinations of these polymers, polyesters, polyamides, polyvinyl polymers, and copolymers, and polylactic acid (PLA). Preferred resins are polyethylene, low density, high density, or linear low density, and combinations thereof, as well as polypropylene coated or laminated with a layer of polyethylene, and polyesters. An object of the present invention is to provide strength, integrity, and support for the bag structure through the use of materials that provide improved performance.

The solid plastic film to which the mesh tubes are adhered is comprised of various thermoplastic resins or polymers or combinations thereof, including but not limited to low density polyethylene, high density polyethylene, linear low density polyethylene, metallocene, and/or polypropylene coated with a layer of polyethylene, films coated with electron-beam surfaces that may or may not be pre-printed, and PLA.

An object of the present invention is for the bag to comprise an outer solid plastic film layer that is printed or reverse-printed with graphics and/or product labeling and then adhered to the mesh tubes using adhesives, laminating with nip rollers, poly extrusion laminating, or some other known means of attaching the two layers, including adhesive tie-layer resins or their blends. Inks involved in the printing process may or may not be water-based. The mesh tube comprises the inside layer of the bag, giving the package strength and integrity. A layer of transparent or colored film may also serve as an inside liner of the bag, and may or may not be printed. The outside film layer also is treated or otherwise coated on one side with any material that alters the level of slipperiness or tackiness of the outer surface, including the static coefficient of friction measure, making the bags less likely to slip during manufacturing, transporting or storing.

It is an object of the present invention to also include various methods of sealing and shutting the bags on the top and bottom, including but not limited to sewing, stitching, stapling, using adhesives or heat seals to close the top and bottom of the bag, using a cooperating profile or matable profile technology for resealing, or inserting a tear-strip in one end of the bag for easy opening.

It is an object of the present invention for the bag's outer and/or inner layers of film to be comprised of polypropylene coated or laminated with polyethylene.

It is an object of the present invention for the bag to be made of a woven mesh material and film layers comprising a polyethylene, polyester, polypropylene, or other polymer resin to which a degradable additive is added, typically in pellet form, during extrusion or other manufacturing processes.

It is an object of the present invention for the bag to comprise a woven mesh comprising PLA. The layer of solid plastic film may also comprise PLA.

It is an object of the present invention for the bag to comprise a solid plastic film layer that may be printed and then coated or covered with an electron-beam curable material. The EB-cured side of the bag comprises the outer surface of the bag.

It is an object of the present invention for the bag to comprise layers adhered by adhesive tie-layer resins or their blends. These and comparable adhesive resins are unique thermoplastic polymers designed to bond a wide variety of substrates, including substrates with dissimilar materials. The resins may or may not be blended with low density polyethylene or some other polymer to provide excellent adhesion between the outside film layer and the inner woven mesh layer.

### BRIEF DESCRIPTION OF THE DRAWINGS

FIG. 1 is a depiction of a side view of composite layers of a package in accordance with an embodiment of the present invention.

### DESCRIPTION OF THE PREFERRED EMBODIMENTS

The description of preferred embodiments is intended to be read in connection with the accompanying drawing, which is to be considered part of the entire written description of this invention. The drawing figure is not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “joined,” “connected,” and “interconnected,” refer to a relationship wherein structures are secured or attached to one another either directly or indirectly through intervening structures, as well as both movable or rigid attachments or relationships, unless expressly described otherwise.

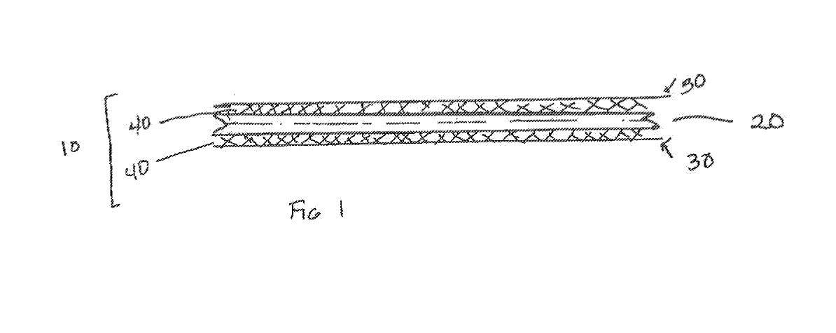

FIG. 1 shows a side view of one embodiment of the present invention comprising a composite bag (10) that is made from a woven mesh tube (20) that is flattened and gusseted. The woven mesh tube (20) provides the integrity and strength of the composite bag (10) and is comprised of thermoplastic synthetic polymers, including but not limited to low density polyethylene, linear low density polyethylene, high density polyethylene, polypropylene coated with a layer of polyethylene, metallocene, electron-beam-cured solid films, polyesters, and PLA, or thermoplastic polymers to which a degradable or compostable additive is added, and other synthetic polymers.

In some embodiments, the mesh tube (20) is fed into a laminator with one or two extruders and is laminated using a polylaminate (40) to adhere a layer of solid plastic film (30) to both sides of the flattened and gusseted bag (10). The film layers (30) are comprised of thermoplastic synthetic resins, including but not limited to low, linear low, or high density polyethylene, polypropylene coated with a layer of polyethylene, metallocene, electron-beam-cured film, polyester, PLA, or thermoplastic polymers to which a degradable or compostable additive is added. The film layers (30) are either printed or reverse-printed using a flexographic or other printing method.

In some embodiments of the present invention, a 70-gauge OPP (oriented polypropylene) film in tube form is used, whereby the film is flattened, unwound from a roll and fed through one or two laminators or extruders on top and bottom of the flattened tube. A solid plastic film is reverse-printed (i.e., so print is on underside of the outside layer of the bag), then unwound from a roll and laminated using nip rollers, or some other known means of adhering, to both sides of the polypropylene mesh/woven flattened tube using polyethylene blended with a tie resin (i.e., a resin that adds additional adhesive properties to the film). This laminated product is wound into a large roll. The roll is then taken to a bag line, where the bags are formed, optionally with side gussets (folds/creases that give the bag a three-dimensional quality), cut to bag length, then sewn shut. A two-ply structure is the result, with (a) one layer of solid film and (b) one layer of woven-mesh fabric with (a) and (b) adhered by a layer of tie resin. Some embodiments may also include an inside layer of solid film that acts as a liner on the inside of the bag.

In accordance with some embodiments, an adhesive tie-layer resin may be used to adhere separate layers of the bag. A tie-layer resin, a blend of tie-layer resins, or a similar adhesive resin may be used. Such resins may include, for example, ethylene vinyl acetate (EVA), modified EVA, ethylene acrylic acid (EAA), ethylene methyl acrylate (EMA), anhydride-modified polyolefins (AMP), or other suitable polyolefin copolymers. The adhesive tie-layer resin may or may not be blended with low density polyethylene and used to adhere the outer printed film layer to a woven layer comprising polypropylene. Examples of adhesive tie-layer resins or their blends commercially available and useful in embodiments of this invention include, but are not limited to, Bynel® resins manufactured by DuPont, Plexar® resins manufactured by Equistar (Lyondell), and Lotader® resins manufactured by Arkema (Atofina).

Some embodiments comprise a bag that is made of a solid plastic film layer that may be printed and then coated or covered with an electron-beam curable (EB curable) material. In such an embodiment, the EB-cured side of the bag would comprise the outer surface of the bag.

In accordance with an embodiment of the present invention, the bag is then sealed on one end, utilizing one of the following closure or sealing methods: sewing, stitching, stapling, using adhesives or heat seals, a cooperating profile technology, or inserting a tear-strip in one end of the bag for easy opening. One method to seal the bag is to roll one end of the finished bag, so that a fold is created, with a fold of about 0.5 to 5 inches preferred, and a fold of about 0.5-2 inches particularly preferred. A hot melt glue or adhesive bead may be added across the width of the bag inside the fold, whereupon the fold is compressed to seal the bag.

An alternative closure method employs folding over one edge of the bag (top or bottom) so that a fold of about 0.5-5 inches is formed, which is then taped using a clear polymeric tape so as to hold the folded edge in place and seal such edge. A tear strip or tear tape may preferably be added within the strip of tape, so that one may readily pull the tear strip in order to release the tape from the bag. Alternatively, a tear strip, tear tape, or other easy-open feature may be formed by perforating the substrate of the bag or the polymeric tape used to hold the folded edge in place. Such perforation can be done by any suitable means, including, for example, by use of a laser.

In a further preferred embodiment of the present invention, a resealing feature may also be included inside the fold, including but not limited to the following: (a) a male strip intersecting with a female groove; (b) slider tabs; (c) metal tabs extending beyond the side edges of the bag so that a top portion of the resealable package can be folded over and the tabs can be bent to hold the bag closed; (d) hook-and-loop-type closure strips; (e) a conventional zipper; or (f) a re-joinable adhesive release liner.

It is to be understood that the present invention is by no means limited only to the particular constructions herein disclosed and shown in the drawings. The appended claims should be construed broadly to cover any variations or modifications within the scope or range of equivalents of the claims.

We claim:

1. A composite bag for packaging bulk food products, which comprises (a) a layer of polymeric solid film and (b) a layer of polymeric mesh woven fabric, wherein a tie resin added during manufacture of said composite bag adheres (a) to (b), said composite bag being sealed on one end during manufacture, wherein at least one end of said composite bag is rolled during manufacture, forming a fold in said composite bag, and further comprising within said fold at least one of the following: (a) a male strip intersecting with a female groove; (b) slider tabs; (c) metal tabs; (d) hook-and-loop-type closure strips; (e) a conventional zipper; and (f) a re-joinable adhesive release liner, and wherein at least one of said layers of polymeric solid film.

2. The composite bag as recited in claim 1, wherein said layer of polymeric solid film comprises a material selected from the group consisting of uncoated polypropylene, low density polyethylene, high density polyethylene, linear low density polyethylene, metallocene, polyester, polypropylene coated with polyethylene, and combinations thereof.

3. The composite bag as recited in claim 1, wherein said layer of polymeric mesh woven fabric comprises a material selected from the group consisting of uncoated polypropylene, low density polyethylene, linear low density polyethylene, polypropylene coated with polyethylene, high density polyethylene, metallocene, copolymers of ethylene and propylene, polyesters, polyamides, polyvinyl polymers, and combinations thereof.

4. The composite bag as recited in claim 1, wherein a tear strip is within said fold.

5. The composite bag as recited in claim 1, wherein said composite bag is resealable.

6. The composite bag as recited in claim 1, further comprising side gussets.

7. The composite bag as recited in claim 4, wherein said tear strip is formed by a laser.

8. A method of manufacturing a composite bag for packaging bulk food products, which comprises: (a) feeding through a nip roller device a combination of a polymeric solid film in roll form and a polymeric mesh woven fabric that is shaped into a tubular structure, with a tie resin added during manufacture to adhere said combination, wherein a flattened tube laminated or adhered on both sides to a polymeric solid film in the form of a roll is formed; and (b) cutting said roll into individual composite bags, wherein each composite bag is sealed on one end, wherein one end of said composite bag is rolled during manufacture, forming a fold in said composite bag, and further comprising within said fold at least one of the following: (a) a male strip intersecting with a female groove; (b) slider tabs; (c) metal tabs; (d) hook-and-loop-type closure strips; (e) a conventional zipper; and (f) a re-joinable adhesive release liner, and wherein at least one of said layers of polymeric solid film.

9. The method as recited in claim 8, wherein said polymeric solid film comprises a material selected from the group consisting of uncoated polypropylene, low density polyethylene, high density polyethylene, linear low density polyethylene, metallocene, polyester, polypropylene coated with polyethylene, and combinations thereof.

10. The method as recited in claim 8, wherein said polymeric mesh woven fabric comprises a material selected from the group consisting of uncoated polypropylene, low density polyethylene, linear low density polyethylene, polypropylene coated with polyethylene, high density polyethylene, metallocene, copolymers of ethylene and propylene, polyesters, polyamides, polyvinyl polymers, and combinations thereof.

11. The method as recited in claim 8, wherein a tear strip is within said fold.

12. The method as recited in claim 8, wherein said composite bag is resealable.

13. The method as recited in claim 8, wherein said composite bag further comprises side gussets.

14. The method as recited in claim 11, wherein said tear strip is formed by a laser.
